(19) United States
(12) Patent Application Publication
(10) Pub. No.: US 2022/0238261 A1
(43) Pub. Date: Jul. 28, 2022

(54) High Adhesion Resistive Composition

(71) Applicant: Ferro Corporation, Mayfield Heights, OH (US)

(72) Inventors: Ponnusamy Palanisamy, Lansdale, PA (US); Andrew Schuster, Exton, PA (US)

(21) Appl. No.: 17/615,193

(22) PCT Filed: May 26, 2020
(86) PCT No.: PCT/US2020/034494

§ 371 Date: Nov. 30, 2021

Related U.S. Application Data
(60) Provisional application No. 62/859,313, filed on Jun. 10, 2019.

(51) Int. Cl. H01C 17/065; G01K 7/18; H01C 7/00; H01C 1/01

(52) U.S. Cl. CPC H01C 17/06553; H01C 1/01; H01C 7/003; G01K 7/18

(57) ABSTRACT

A resistive composition is provided to form thick film resistors on a substrate. The resistive composition includes platinum particles and ceramic particles. The ceramic particles include alumina particles. An organic vehicle can be included to form an ink or paste for thick film process. After application to the substrate, the resistive composition is fired to form the thick film resistors, which is fully adhered to the substrate.

### FIELD

The present invention relates to a resistive composition comprising platinum (Pt) particles and alumina (Al₂O₃) particles for producing a thick film resistor, and a method for producing the thick film resistor therefrom. The present invention also relates to thick film resistors formed from the resistive compositions. In addition, the present invention also relates to the sensors and other electronic devices including thick film resistors, such as a resistance temperature detector (RTD), a particulate matter (PM) sensor (sensing electrodes and/or resistive heaters), a resistance heater, and the like.

### BACKGROUND

A thick film resistor is typically produced by forming a film including a resistive composition that contains predetermined amounts of conductive components and insulating components on various carrier substrates and fired at high temperature. For example, a thick film resistor composition can be prepared as an ink or a paste, and printed on a ceramic substrate or a glass substrate to have a predetermined shape. After the resistor composition is formed, it is dried to evaporate solvents, then fired at high temperatures. A resistance value can be adjusted by trimming the fired resistor composition.

The resistor can be used in a variety of different sensors and devices, such as a resistance temperature detector (RTD), a particulate matter (PM) sensor, a resistance heater and the like. Such sensors and devices have applications, inter alia, in the automotive industry. These sensors and devices include platinum (Pt) thin film formed on a ceramic substrate. In one example, platinum thin film can be prepared by a thin film deposition such as sputtering process, followed by a thin film lithography process, which require costly processing equipment, and correspondingly results in a high manufacturing cost of platinum thin film based resistors, and the sensor and devices including platinum thin film based resistors. Accordingly, it is desired to have a technology for manufacturing the platinum based resistor with reduced manufacturing cost.

Further, it is required that the resistor elements applied to a substrate, to be used in the RTD, PM sensor and/or resistive sensor, have chemical resistance and mechanical strength to withstand corrosive gas and high speed particles generated during the operation of an internal combustion engine, as well as thermal stability to withstand thermal shock, for example, temperature extremes ranging from −50° C. to 900° C. for PM sensor. It is also necessary that the resistor elements meet electrical properties such as a temperature coefficient of resistance (TCR) or controlled resistivity, as required in each sensor or device application. Also it is desirable that the resistor elements be fully adhered to the underlying substrate during the operation of sensors or other devices including the resistor elements. Further, it is desirable that the resistor elements be compatible with laser trimming or plasma ablation trimming process such that the electrical properties of the resistor elements are uniform and close to the design values.

As such, there exists a need for improved conductive paste formulations to produce sensors as noted herein, which address the shortcomings of the previous formulations.

### SUMMARY

The difficulties and drawbacks associated with previously known systems are addressed in the present compositions, methods, and assemblies.

In one aspect, the present subject matter provides a resistive composition. The resistive composition comprises, prior to firing, an organic portion, and a solid portion. The solid portion comprises from about 30 to about 70 vol % platinum particles, and from about 30 to about 70 vol % alumina particles. D50 of platinum particles is from about 0.7 micron to about 2.0 micron, preferably from about 1.0 micron to about 1.8 micron, and more preferably about 1.5 micron. D50 of alumina particles is from about 0.05 micron to about 0.25 micron, preferably from about 0.07 micron to about 0.18 micron, and more preferably about 0.1 micron.

In another aspect, the present subject matter provides a resistor film formed on a substrate by firing the resistive composition according to the present invention. A temperature coefficient of resistance (TCR) of the resistor film ranges from about 3685 to about 3925 ppm/° C. Resistivity of the resistor film ranges from about 0.05 to about 2 ohm per square. The substrate for the resistor film is selected from alumina, zirconia toughened alumina, aluminum nitride, and silicon nitride, and combinations thereof. The resistor formed on the substrate preferably does not have a discontinuous interface layer between the resistor film and the substrate and achieve improved adhesion between the resistor and the substrate.

In yet another aspect, the present subject matter provides a method of forming a device. A resistive composition according to the present invention is applied to a substrate. A conductive composition is applied to form at least one of a lead line and a pad for welding. Subsequently, the resistive composition and the conductive composition applied to the substrate is fired at a temperature from about 1250° C. to about 1500° C. The resistive composition and the conductive composition applied to the substrate is fired preferably at from about 1300° C. to about 1400° C. More preferably, the resistive composition and the conductive composition applied to the substrate can be fired at about 1350° C., which is lower than the firing temperature of 1450-1550° C. of high temperature co-fired ceramic (HTCC). In another embodiment, the resistive composition and the conductive compositions can be co-fired at from about 1300° C. to about 1400° C., preferably at about 1350° C.

In still yet another aspect, the present subject matter provides a device. The device comprises a resistor film comprising a solid portion, prior to firing, according to the present invention, the resistor film being disposed on a substrate. The device also comprises a lead line for connecting the resistor film to an exterior device such as an external electrical load or electrical device. The substrate is selected from alumina, zirconia toughened alumina, aluminum nitride, and silicon nitride, or the combinations thereof. The device includes a RTD, a PM sensor, a resistance heater.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a top view schematic of a Resistance Temperature Detector chip component based on a laser trimmable thick film composition in accordance with one embodiment of the present subject matter;

FIG. 2 is a cross-sectional view of the Resistance Temperature Detector of FIG. 1 in accordance with one embodiment of the present subject matter;

FIG. 3 is a scanning electron micrograph (SEM) image of platinum particles useful in platinum-alumina thick film compositions in accordance with one embodiment of the present subject matter;

FIG. 4 is an SEM image of alumina particles useful in platinum-alumina thick film compositions in accordance with one embodiment of the present subject matter;

FIG. 5 is a graph of resistivity of platinum-ceramic thick film compositions as a function of platinum loading in accordance with one embodiment of the present subject matter;

FIG. 6 is a plot for temperature coefficient of resistance for a thick film resistor with addition of Rh in accordance with one embodiment of the present subject matter. The thick film resistor was fired at 1350° C. for 30 minutes in ambient atmosphere; and

FIG. 7 is a SEM image for thick film resistors formed on pre-fired alumina substrate in accordance with one embodiment of the present subject matter.

### DETAILED DESCRIPTION OF THE EMBODIMENTS

The present invention described herein provides a thick film resistor composition, which contains platinum particles and ceramic particles, for use in producing electronic component, such as, resistance temperature detectors (RTDs), particulate matter (PM) sensors—interdigitated electrodes and/or heater resistor, and resistance heaters for sensors operating at high temperature, for example, above 600° C., above 700° C., above 800° C., above 900° C. or above 1000° C.

Resistance temperature detectors (RTDs) are widely used, owing in part to their advantages of easy installation, availability over wide temperature range, and operational stability over extended time period. One way of producing RTDs is based on thin film processing. Specifically, platinum based thin film RTDs can be produced by vacuum deposition process such as radiofrequency (RF) sputtering technique, followed by thin film photolithography for adjusting any significant variation in resistance in platinum trace patterns. Typically, thin film processing and photolithography requires relatively high cost initial investment and long processing times, which results in the increase in the manufacturing cost of thin film based RTDs.

The automotive industry requires an exhaust gas sensor sensing the exhaust gas from an internal combustion engine at very high temperatures such as from about 700° C. to about 1000° C. The exhaust gas sensor includes an electrode including an electrically conductive material for sensing charged particles from the exhaust gas. Further, during engine operation, the exhaust gas sensor is exposed to particles (soot) that physically collide with and abrasive to the surface of the sensor. Therefore it is desired that the sensor be mechanically fully adhered to the substrate to prevent the sensor electrodes from separating from the substrate. The exhaust also contains corrosive gas. Accordingly, the chemical stability of the exhaust gas sensor is a key consideration in design. Accordingly, materials with high thermal, chemical and mechanical stability are suitable for the exhaust gas sensor.

The present invention relates to a resistive thick film composition which is fired and used to produce a low cost RTD element, a low cost RTD chip component including the low cost RTD element, a particulate matter (PM) sensor electrode, a resistive heater for a PM sensor, or an integrated heating element requiring chemically, thermally, and mechanically stable operation.

In an embodiment of the invention, the resistive thick film composition includes a solid portion and organic vehicle. The solid portion includes a resistive component that is made from a mixture of ingredients. The resistive thick film composition can be an ink or a paste that are used to form a resistor after firing at an elevated temperature. In one embodiment, the resistor can be a thick film resistor. After firing, the resistor can be laser-trimmed to control or adjust uniformity of the resistor patterns or resistivity values required for certain applications.

In one embodiment, the resistive composition is devoid of glass. For example, such embodiment does not include any glass compositions in the form of glass powder or glass frit. In another embodiment, the resistive composition is devoid of metallic elements such as Fe, Ni, Mn, Co, Cu, or Cr, nor their oxides such as FeO, NiO, MnO, CoO, CuO, or Cr₂O₃. In yet another embodiment, the resistive composition is devoid of alkali metals, such as, Na, K, or Li, and is devoid of alkali metal oxides, such as Na₂O, K₂O, or Li₂O. In still yet another embodiment, the resistive composition excludes reducible oxides such as ZnO, FeO, CoO, Cr₂O₃, PbO, CdO or Bi₂O₃ that are reduced to metals such as Zn, Fe, Co, Cr, Pb, Cd, or Bi. In another embodiment, the resistive composition excludes any glass compositions, metallic elements such as Fe, Ni, Mn, Co, Cu, or Cr and their oxides, alkali metals such as Na, K, or Li and their oxides Na₂O, K₂O, or Li₂O, and reducible oxides ZnO, FeO, CoO, Cr₂O₃, PbO, CdO or Bi₂O₃. Minor additions, preferably less than 100 ppm, of glasses, metallic elements such as Fe, Ni, Mn, Co, Cu, or Cr and their oxides, alkali metals and their oxides, and reducible oxides are tolerable in these applications, such are completely lacking in preferred embodiments of the invention.

As has been stated, the present invention forms resistive elements in various electronic devices. While the borderline between conductors and resistors is often unclear, the resistor composition of the present invention, after firing, exhibits a minimum resistivity of about 0.01 ohm per square (Ω/) or above.

It should, of course, be understood that the description and drawings herein are merely illustrative and that various modifications and changes can be made in the structures disclosed without departing from the present disclosure. In general, the figures of the exemplary resistor layer are not necessarily to scale. It will also be appreciated that the various identified components of the drawings herein are merely terms of art that can vary from one manufacturer to another and should not be deemed to limit the present disclosure.

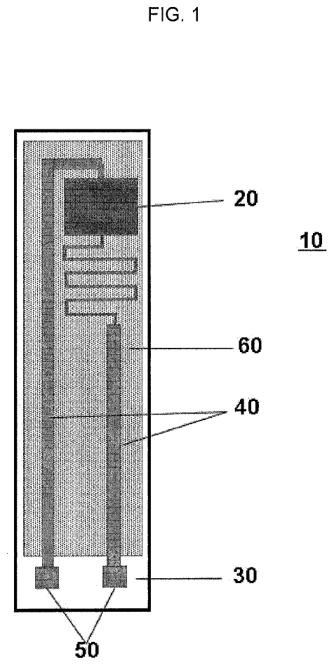

Exemplary configuration of a RTD chip component including a resistor according to the present invention will now be described in more detail with reference to FIG. 1. It will be understood that figures are merely illustrative and that the present subject matter includes other configurations for the RTD chip component including a resistor. It will also be understood that the description provided herein of a resistor into the RTD chip component, will also apply to incorporating a resistor into any other sensors or application listed herein.

As seen in FIG. 1, an RTD chip component 10 includes a thick film resistor 20 according to several embodiments of the present invention. The thick film resistor 20 is formed on a substrate 30. The resistor 20 can include line patterns with predetermined width and thickness. In one embodiment, the resistor 20 is serpentine resistor elements with controlled line width and spacing. In another embodiment, the resistor 20 includes interdigitated resistor elements. In yet another embodiment, the resistor 20 includes one or more area pattern as illustrated in FIG. 1. Alternately, the resistor 20 can be a combination of line patterns and one or more area patterns. The resistor 20 can be connected to lead line 40, which typically is a low resistivity platinum. The lead line 40 is formed by thick film process such as screen printing with resistor patterns formed. For example, the lead line 40 is formed from Pt composition 5599-P, commercially available from Ferro Corporation, Cleveland, Ohio, USA. Alternately, the lead line 40 can be formed by thin film deposition process followed by lithography process.

One end of the lead line 40 can be terminated by a pad for welding 50 for electrically connecting with an exterior device. For the welding pad, a thick film composition (for example, 5562-A, commercially available from Ferro Corporation, Cleveland, Ohio, USA) is applied to the substrate 30 by thick film process. Alternately, the lead line 40 can be designed to include the pad for welding 50. Optionally, an overcoat 60 is formed on the substrate 30 to cover at least a portion of the thick film resistor 20, lead line 40, and pad for welding 50. The overcoat 60 can include a glass composition, and can be formed by thick film process. For example, thick film composition (4999-S8, commercially available from Ferro Corporation, Cleveland, Ohio, USA) can be used to form the overcoat 60. Alternately, the overcoat 60 includes a ceramic or ceramic-glass.

As set forth above, each of the resistor 20, lead line 40, pad for welding 50, and overcoat 60 can be formed by thick film process, such as screen printing, followed by drying at 125° C. for 15 minutes. Subsequently, the resistor 20, lead line 40, pad for welding 50, and overcoat 60 can be co-fired at a temperature between from about 1250° C. to about 1500° C. In one example, co-firing temperature can be about 1350° C. to have a dense microstructure after co-firing and at the same time to be ready for a laser trimming process after co-firing.

Alternately, depending on the composition of the resistor 20, lead line 40, pad for welding 50, and overcoat 60, multi-step firing can be performed. For example, the softening point of the overcoat 60 can be significantly lower than the firing temperature for remaining layers such as the resistor 20, lead line 40, and pad for welding 50. In this case, each of the resistor 20, lead line 40, and pad for welding 50 can be sequentially formed by screen-printing followed by drying. Then, the resistor 20, lead line 40, and pad for welding 50 are co-fired at a temperature between from about 1250° C. to about 1500° C., preferably from about 1300° C. to about 1400° C., and more preferably about 1350° C. Subsequently the overcoat 60 can be formed on at least a portion of the resistor 20, lead line 40 and pad for welding 50, and then fired at a temperature range between from about 1150° C. to about 1350° C. In one example, the co-firing temperature can be about 1350° C. The firing temperature is less than a softening point of the substrate.

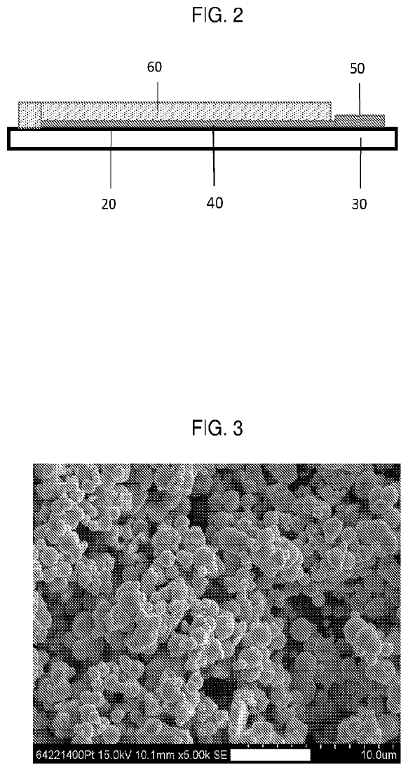

FIG. 2 is a schematic of cross-sectional view of the RTD chip component 10 of FIG. 1 in accordance with one embodiment of the present subject matter. FIG. 2 shows that the resistor 20, lead line 40, and pad for welding 50 are formed on the upper surface of the substrate 30, and the overcoat 60 covers at least a portion of the resistor 20, lead line 40, and pad for welding 50.

One requirement for the RTD chip component is a temperature coefficient of resistance (TCR). It is typically known that TCR for platinum based RTD is about 3850 ppm/° C.

The various aspects of the present subject matter will be now described in more detail.

Resistive Composition

As described above, the resistive composition includes a solid portion and an organic vehicle. The solid portion comprises a metal and a ceramic component. The metal can be platinum (Pt). The ceramic component can be alumina (Al₂O₃). In another embodiment, cordierite can be used as the ceramic component. The solid portion can include up to 10 wt % of other solid additives as needed.

The solid portion for the resistive composition according to the present invention comprises: (a) a metal component comprising from about 30 to about 70 vol % platinum; (b) a ceramic component comprising from about 30 to about 70 vol % alumina. In another embodiment, the solid portion of the resistive composition comprises: (a) a metal component comprising from about 35 to about 50 vol % platinum, and (b) a ceramic component comprising from about 50 to about 65 vol % alumina.

With respect to the organic portion, a preferred composition according to the present invention is as follows: (a) from about 80 to about 90 vol % organic solvent, (b) from about 10 to about 20 vol % binder; and (c) from about 0 to about 5 vol % total of dispersants, plasticizers, and/or thixotropic agents. Each of these major ingredient types in the solid portion and the organic portion is detailed hereinbelow.

Solid Portion

The solid portion comprises one or more metal components and one or more ceramic components. According to an embodiment of present invention, the metal components comprise fine platinum particles. In one embodiment, the amount of platinum ranges from about 30 to about 70 vol % of the solid portion. In another embodiment, the amount of platinum ranges from about 35 to about 50 vol % of the solid portion. The metal components can include one or more alloy forming metals selected from Rh, Ir, Pd, Au, and Ag, the amount of which ranges from about 0.01 to about 10 vol % of the solid portion. The ceramic components can include fine alumina particles. In another embodiment, the ceramic components can include cordierite particles. In one embodiment, the amount of alumina ceramic component ranges from about 30 to about 70 vol % of the solid portion. In another embodiment, the amount of alumina ceramic component can range from about 50 to about 65 vol % of the solid portion. The amount of cordierite can be decided such that cordierite replaces a portion or all of alumina in the above embodiments. For example, the amount of cordierite ranges from about 10 to about 90 vol % of the alumina.

It is noted that the solid portion preferably contains no glass compositions. Specifically, the solid portion is devoid of any glass compositions in the form of glass powder or glass frit. It is noted that the glass compositions are produced by firing a mixture of oxides or other starting precursors, which are combined and melted at high temperatures to form a molten mixture of precursors, for example, oxides, carbonates or the like. The molten oxides are then quenched to form the glass composition.

In another embodiment, the solid portion is devoid of metallic elements such as Fe, Ni, Mn, Co, Cu, or Cr, nor their oxides such as FeO, NiO, MnO, CoO, CuO, or Cr₂O₃. In still another embodiment, the solid portion is devoid of alkali metals, such as, Na, K, and Li, and is devoid of alkali metal oxides, such as, Na₂O, K₂O, and Li₂O. In yet another embodiment, the solid portion does not contain any reducible oxides such as ZnO, FeO, CoO, Cr₂O₃, PbO, CdO, or Bi₂O₃ that can be reduced to metals such as Zn, Fe, Co, Cr, Pb, Cd, or Bi. In yet another embodiment, the solid portion is devoid of glass compositions, metallic elements such as Fe, Ni, Mn, Co, Cu, or Cr, nor their oxides such as FeO, NiO, MnO, CoO, CuO, or Cr₂O₃, alkali metal and their oxides, and reducible oxides.

Platinum

The resistive composition in the present invention includes preferably platinum particles having about 30 vol % to about 70 vol % of the solid portion. Accordingly, the resistive composition of the present invention can provide a thick film in which a stable resistive trace/patterns can be formed with reduced resistance variation even after the resistive composition is formed on a substrate, followed by firing the formed resistive composition formed on a substrate.

In the present invention, platinum particles are essentially devoid of impurities. For example, platinum particles are essentially devoid of lead (Pb), bismuth (Bi), and cadmium (Cd). For example, platinum particles with only a trace amount of any unintended impurity can be allowed. In one example, the impurity level is be 100 ppm or less.

In the present invention, to be used in the resistive composition, platinum particles having a fine particle size and narrow particle size distribution are desired. Particle size distribution (D50, D10, and D90) was measured by a laser diffraction particle analyzer (LA-910, Horiba, Japan).

In one embodiment, a value at 50% in mass-based cumulative fractions of the particle size distribution measured by a laser particle size distribution measuring apparatus (hereafter referred to as the average particle size D50) is from about 0.3 micron to about 3.0 micron. D10 (a value at 10% in mass-based cumulative fractions of the particle size distribution similarly measured as D50 above) for above subject platinum particles is from about 0.1 micron to about 2.0 micron, and D90 (a value at 90% in mass-based cumulative fractions of the particle size distribution similarly measured as D50 above) is from about 5.0 micron to about 7.5 micron.

In another embodiment, D50 of the subject platinum particles is from about 0.7 micron to about 2.0 micron. D10 for above subject platinum particles is from about 0.1 micron to about 1.0 micron, and D90 is from about 4.0 micron to about 5.5 micron. Preferably, D10 and D90 of platinum particles are about 0.2 micron and about 5.0 micron, respectively.

In yet another embodiment, D50 of the subject platinum particles is from about 1.0 micron to about 1.8 micron, and D10 of the platinum particles is from about 0.2 micron to about 0.6 micron. D90 of platinum particles is from about 1.7 micron to about 4.0 micron.

In still yet another embodiment, D50 of the platinum particles is about 1.5 micron. D10 of the platinum particles is from about 0.3 micron to about 0.6 micron. D90 of the platinum particles is from about 2.1 micron to about 2.8 micron. Preferably, D10 and D90 of the platinum particles are about 0.5 micron and about 2.5 micron, respectively.

By using fine platinum particles with narrow particle size distribution as disclosed herein, the platinum particles can be uniformly distributed in the resistive composition before and after the resistive composition is fired to form a resistive trace, which results in uniform electrical characteristics. Further, a uniform and fine resistor pattern with dense microstructure can be formed after firing. More importantly, fine platinum particles with controlled particle size distribution can be advantageous in reducing firing temperature partly due to increased specific surface area of the platinum particles which can accordingly provide increased driving force during firing at high temperature.

The specific surface area (SSA) of platinum particles can be different depending on, for example, D50, D10, D90 or the like. The specific surface area of platinum particles for resistive composition was measured by BET Method (Micromeritics Co. Gemini Model, USA). In one embodiment, the specific surface area measured ranges from about 0.3 m²/g to about 1.1 m²/g, preferably, preferably from about 0.4 m²/g to about 0.9 m²/g, more preferably from about 0.5 m²/g to about 0.7 m²/g, and most preferably about 0.6 m²/g.

In the present invention, platinum particles can have different morphologies to be used in the resistive composition. In one example, platinum particles can have non-spherical shape. For example, platinum particles can have irregular shape. FIG. 3 shows a scanning electron micrograph (SEM) image for the platinum particles used for the resistive compositions according to one embodiment of the present invention. It is clear that the shape of platinum particle is not fully spherical. Rather, the platinum has an irregular shape. Some platinum particles have plate-shaped. The size of platinum particles ranges from about sub-micron size to about 2.0 micron, and can be advantageous in high density packing.

Ceramic Particles

In the present invention, a predetermined amount of ceramic particles is included in the solid portion of the resistive composition. For example, the ceramic particles are uniformly mixed with platinum particles in the resistive composition such that when the resistive composition is fired, the fired product of solid portion of the resistor exhibits a predetermined resistivity value.

In one example, the solid portion of the resistive composition in the present invention preferably includes from about 30 vol % to about 70 vol % of alumina particles. Accordingly, the solid portion of the resistive composition preferably includes from about 30 vol % to about 70 vol % of platinum particles, and from about 30 vol % to about 70 vol % of alumina particles.

Alumina particles are insulating, and are not electrically conductive. Therefore, in the case of using a mixture of alumina particles and platinum particles for the resistive composition, the electrical properties of the resistive composition, after firing, as well as those of any components made from such composition varies according to the blending ratio between the alumina particles and platinum particles.

In the present invention, similar to platinum particles used in the resistive composition, it is desired that alumina particles have a fine particle size and well-controlled narrow particle size distribution. In one embodiment, D50 of alumina particles is from about 0.05 micron to about 0.6 micron. D10 of above subject alumina particles is from about 0.01 micron to about 0.09 micron, and D90 is from about 0.2 micron to about 0.8 micron.

In another embodiment, D50 of alumina particles is from about 0.05 micron to about 0.25 micron. D10 of above subject alumina particles is from about 0.01 micron to about 0.05 micron, and D90 is from about 0.2 micron to about 0.5 micron, respectively.

In yet another embodiment, D50 of alumina particles is from about 0.05 micron to about 0.6 micron. D10 of alumina particles is about 0.01 micron, and D90 of above subject alumina particles is about 1.0 micron.

In still yet another embodiment, D50 of the subject alumina particles is from about 0.07 micron to about 0.18 micron, and D10 of the alumina particles is from about 0.01 micron to about 0.03 micron. D90 of alumina particles is from about 0.2 micron to about 0.4 micron.

In another embodiment, D50 of the alumina particles is about 0.1 micron. D10 of the platinum particles is from about 0.01 micron to about 0.03 micron. D90 of the alumina particles is from about 0.15 micron to about 0.4 micron. Preferably, D10 and D90 of the alumina particles are about 0.03 micron and about 0.3 micron, respectively.

D10/D90 of different platinum particles and different alumina particles can be combined. In one embodiment, the solid portion includes platinum particles with D10/D90 of (1) about 0.2 micron/about 5.0 micron, and (2) about 0.5 micron/about 2.5 micron. The solid portion also includes alumina particles with D10/D90 of (1) about 0.01 micron/about 1.0 micron, and (2) about 0.03 micron/about 0.3 micron. Accordingly, the solid portion includes Pt particles and alumina particles with combined D10/D90 as shown in Table 1.

TABLE 1
D10/D90 of Pt particles and Al₂O₃ particles
in solid portions of resistive compositions.

| | Example 1 | Example 2 | Example 3 | Example 4 |
|---|---|---|---|---|
| Pt particles | 0.2/5.0 | 0.5/2.5 | 0.2/5.0 | 0.5/2.5 |
| (micron) | | | | |
| Alumina particles | 0.01/1.0 | 0.01/1.0 | 0.03/0.3 | 0.03/0.3. |
| (micron) | | | | |

The specific surface area of alumina particles can be different depending on, for example, D50, D10, D90 or the like. In the present invention, the specific surface area of alumina particles for resistive composition was measured by BET Method (Micromeritics Co. Gemini Model, U.S.A). The specific surface area measured for alumina particles disclosed herein ranges from about 10 m²/g to about 20 m²/g, preferably from about 13 m²/g to about 17 m²/g, and more preferably from about 14 m²/g to about 15 m²/g.

In one embodiments, the solid portion comprises about 30 to about 70 vol % platinum particles, and about 30 to about 70 vol % alumina particles. D50 of platinum particles is from about 0.3 micron to about 3.0 micron. D50 of alumina particles is from about 0.05 micron to about 0.6 micron.

In another embodiment, the solid portion comprises about 30 to about 70 vol % platinum particles, and about 30 to about 70 vol % alumina particles. D50 of platinum particles is from about 0.3 micron to about 3.0 micron, and D50 of alumina particles is from about 0.05 micron to about 0.6 micron. D10 of platinum particles is from about 0.1 micron to about 2.0 micron, and D90 of platinum particles is from about 5.0 micron to about 7.5 micron. D10 of alumina particles is from about 0.01 micron to about 0.09 micron, and D90 of platinum particles is from about 0.2 micron to about 0.8 micron.

In still one embodiments, the solid portion comprises about 30 to about 70 vol % platinum particles, and about 30 to about 70 vol % alumina particles. D50 of platinum particles is from about 0.7 micron to about 2.0 micron. D50 of alumina particles is from about 0.05 micron to about 0.25 micron.

In another embodiment, the solid portion comprises about 30 to about 70 vol % platinum particles, and about 30 to about 70 vol % alumina particles. D50 of platinum particles is from about 0.7 micron to about 2.0 micron, and D50 of alumina particles is from about 0.05 micron to about 0.25 micron. D10 of platinum particles is from about 0.1 micron to about 1.0 micron, and D90 of platinum particles is from about 4.0 micron to about 5.5 micron. D10 of alumina particles is from about 0.01 micron to about 0.05 micron, and D90 of platinum particles is from about 0.2 micron to about 0.5 micron.

In yet another embodiment, the solid portion comprises about 30 to about 70 vol % platinum particles, and about 30 to about 70 vol % alumina particles. D50 of platinum particles is from about 1.0 micron to about 1.8 micron. D50 of alumina particles is from about 0.07 micron to about 0.18 micron.

In still yet another embodiment, the solid portion comprises about 30 to about 70 vol % platinum particles, and about 30 to about 70 vol % alumina particles. D50 of platinum particles is from about 1.0 micron to about 1.8 micron. D50 of alumina particles is from about 0.07 micron to about 0.18 micron. D10 of platinum particles is from about 0.2 micron to about 0.6 micron, and D90 of platinum particles is from about 1.7 micron to about 4.0 micron. D10 of alumina particles is from about 0.01 micron to about 0.03 micron, and D90 of platinum particles is from about 0.2 micron to about 0.4 micron.

In yet another embodiment, the solid portion comprises about 30 to about 70 vol % platinum particles, and about 30 to about 70 vol % alumina particles. D50 of platinum particles is about 1.5 micron, and D50 of alumina particles is about 0.1 micron.

In another embodiment, the solid portion comprises about 30 to about 70 vol % platinum particles, and about 30 to about 70 vol % alumina particles. D50 of platinum particles is about 1.5 micron, and D50 of alumina particles is about 0.1 micron. D10 of platinum particles is from about 0.3 micron to about 0.6 micron, and D90 of platinum particles is from about 2.1 micron to about 2.8 micron. D10 of alumina particles is from about 0.01 micron to about 0.03 micron, and D90 of platinum particles is from about 0.15 micron to about 0.4 micron.

In another embodiment, the solid portion comprises about 30 to about 70 vol % platinum particles, and about 30 to about 70 vol % alumina particles. D50 of platinum particles is about 1.5 micron, and D50 of alumina particles is about 0.1 micron. D10 of platinum particles is about 0.5 micron, and D90 of platinum particles is about 2.5 micron. D10 of alumina particles is about 0.03 micron, and D90 of platinum particles is about 0.3 micron.

In one embodiments, the solid portion comprises about 30 to about 70 vol % platinum particles, and about 30 to about 70 vol % alumina particles. D50 of platinum particles is from about 0.3 micron to about 3.0 micron. D50 of alumina particles is from about 0.05 micron to about 0.6 micron. D10 of platinum particles is about 0.2 micron, and D90 of platinum particles is about 5.0 micron. D10 of alumina particles is about 0.01 micron, and D90 of platinum particles is about 1.0 micron.

In other embodiments, the solid portion comprises about 30 to about 70 vol % platinum particles, and about 30 to about 70 vol % alumina particles. D50 of platinum particles is from about 0.3 micron to about 3.0 micron. D50 of alumina particles is from about 0.05 micron to about 0.6 micron. A specific surface area of platinum particles is from about 0.3 m²/g to about 1.1 m²/g, and a specific surface area of alumina particles is from about 10 m²/g to about 20 m²/g.

In other embodiments, the solid portion comprises about 30 to about 70 vol % platinum particles, and about 30 to about 70 vol % alumina particles. D50 of platinum particles is from about 0.3 micron to about 3.0 micron. D50 of alumina particles is from about 0.05 micron to about 0.6 micron. A specific surface area of platinum particles is from about 0.6 m²/g to about 0.7 m²/g, and a specific surface area of alumina particles is from about 14 m²/g to about 15 m²/g.

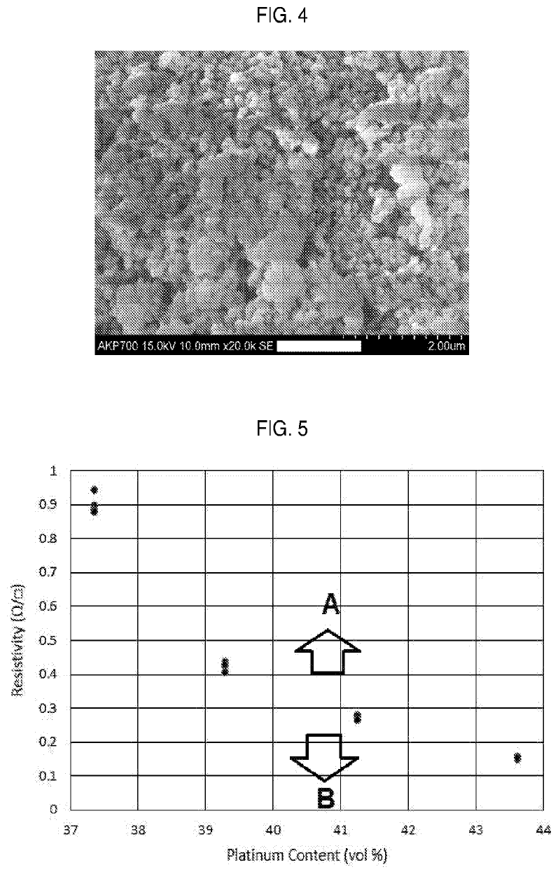

Similar to platinum particles, alumina particles for resistive composition can have non-uniform morphology. For example, platinum particles can have non-spherical shape. In another example, alumina particles can have irregular shape. FIG. 4 shows a SEM image for alumina particles used for the resistive compositions according to one embodiment of the present invention. It is clear that the shape of alumina particle is quite non-uniform. Instead, alumina particles have irregular shape, which can be advantageous for improved particle packing. The size of alumina particles from FIG. 4 ranges from about 0.1 micron to about 0.2 micron.

In one embodiment, cordierite can be mixed with platinum particles to form a resistive composition. For example, the solid portion of the resistive composition includes at least one of cordierite and alumina, and mixed with platinum to form a thick film resistor.

FIG. 5 illustrates the resistivity of a thick film resistor including platinum particles and alumina particles as a function of the proportion of platinum particles varying between from about 37.3 vol % to about 43.6 vol %. Resistivity was measured based on ASTM B193-16, Standard test method for resistivity of electrical conductor materials using a multi-meter (Fluke 8840A, U.S.A), such method incorporated herein by reference, and was normalized to the value of a thick film resistor thickness of 10 micron after firing. The resistivity of the thick film resistor is inversely proportional to the amount of platinum present in the resistive composition. The resistivity of the thick film resistor in FIG. 5 ranges from about 0.15 to about 0.9Ω/ (ohms per square). For example, resistivity of about 0.15Ω/ was measured for about 43.6 vol % platinum loading, and resistivity of about 0.9Ω/ was measured for about 37.3 vol % platinum loading. Resistivity of the thick film resistor further varies by changing the relative ratio of platinum in the resistive composition. For example, while not shown in FIG. 5, resistivity of the thick film resistor further reduces to about 0.05 ohm per square for about 65-70 vol % platinum, and further increases to about 2 ohm per square for about 30-34 vol % platinum.

In addition to the relative amount of platinum particles in the resistive composition, the resistivity of the thick film resistor was also substantially controlled or modified by the average particle sizes of the platinum and alumina, respectively. For example, the curve shown in FIG. 5 shifted in an upward direction (A) when the platinum particle size increased while the ceramic particle size was unchanged. In another example, the curve shown in FIG. 5 shifts in an upward direction (A) when the ceramic particle size decreased while the platinum particle size was unchanged. On the other hand, the curve shown in FIG. 5 shifts in a downward direction (B) when the ceramic particle size increases while the platinum particle size was unchanged. These trends are related with the connectivity of platinum particles in the solid portion. As the platinum particle size increases, the number of platinum particles and the specific surface area of platinum particles decreases for a fixed platinum amount in the solid portion. Therefore, it is likely that the platinum particles make less contact with neighboring platinum particles. As a result, overall conductivity decreases, and the resistivity increases.

It is desired that the resistor based on platinum according to embodiments of the present invention has TCR of from about 3685 to about 3925 ppm/° C., preferably from about 3750 to about 3900 ppm/° C., and more preferably from about 3770 to about 3850 ppm/° C. In another embodiment, the TCR ranges from about 3685 to about 3820 ppm/° C. For the thick film resistors in Table 2, TCRs of about 3850-3895 ppm/° C. were measured for different Pt-based compositions. For example, composition 1 in Table 2 includes 50 vol % Pt and 50 vol % alumina, and a thick film resistor prepared from composition 1, after firing, has TCR of about 3850 ppm/° C. Composition 2 is similar to composition 1 in that both composition 1 and composition 2 include platinum particles and alumina particles. On the other hand, composition 2 indicates that TCR of thick film resistor can be controlled by modifying relative ratio between Pt and alumina. For example, an increase in the proportion of Pt from 50 vol % (composition 1) to 507 vol % (composition 2) resulted in the increase in TCR from about 3850 ppm/° C. (composition 1) to about 3861 ppm/° C. (composition 2). Table 2 also shows that composition 3 includes Pt and calcium borosilicate glass, and a thick film resistor from composition 3 has TCR of about 3893 ppm/° C. While TCRs for compositions 1 and 3 differ by about 1% from each other, composition 3 requires about 96.6 vol % Pt particles, which is almost twice Pt particles in composition 1. Therefore, combining platinum and alumina particles is more advantageous than combining platinum and calcium borosilicate glass composition in terms of reducing the amount of costly platinum in the resistive compositions. The thick film resistors prepared from compositions 1 and 3 in Table 2 were fired at 1350° C. for 30 minutes in ambient atmosphere before TCR was measured. The thick film resistors prepared from composition 2 in Table 2 were fired at 1500° C. for 90 minutes in ambient atmosphere before TCR was measured. TCR was measured using a multi-meter (Sun Systems with a Keithley 3706 system switch multi-meter and Lab View software) from 0° C. to 100° C.

TABLE 2
Resistive compositions with TCR (0 to 100 C)

| | Resistive composition (vol %) | TCR (ppm/° C.) |
|---|---|---|
| composition 1 | 50% Pt + 50% alumina | 3850 |
| composition 2 | 50.7% Pt + 49.3% alumina | 3861 |
| composition 3 | 96.6% Pt + 3.4% of a calcium | 3893 |
| | borosilicate glass | |

Other Additives

In the solid portion of the resistive composition, one or more metals can be generally added to a mixture of platinum particles and ceramic particles (ex. alumina) for the purpose of adjusting and modifying resistance characteristics such as temperature coefficient of resistance (TCR). For example, one or more alloy forming metals include noble metal elements including, but not limited to rhodium (Rh), iridium (Ir), palladium (Pd), gold (Au) or silver (Ag), which prefer being in metallic form to form an alloy with Pt at elevated temperature, i.e., equal to or above about 1350° C. The amount of the metallic additives in the solid portion of a resistive composition is generally from about 0.01 vol % to about 10 vol % for adjusting TCR of a thick film resistor after firing.

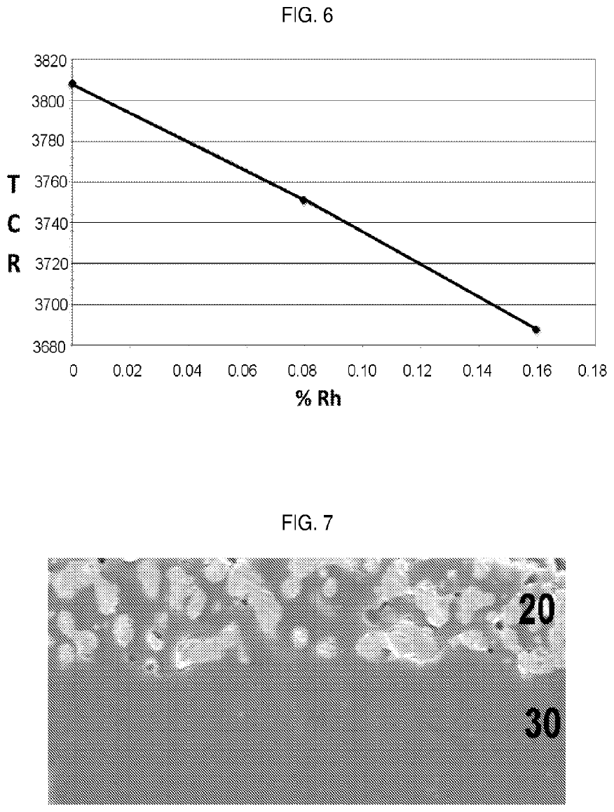

In one embodiment according to the present invention, addition of Rh to the resistive composition reduces TCR of the resistive composition with no Rh addition. FIG. 6 shows the TCR of the thick film resistors prepared from a resistive composition with addition of Rh in accordance with one embodiment of the present subject matter. The thick film resistors include a solid portion comprising 45 vol % platinum particles and 55 vol % alumina particles. Rh can be added to the resistive thick film composition via multiple routes. First, Rh particles smaller than platinum particles can be incorporated into the solid portion of a resistive thick film composition. Alternately, a metal-organic compound including Rh can be added to the thick film composition, which can be preferable when adding relatively small amount such as 1000 ppm of Rh is desired.

In this test, the TCR ranges from about 3685 to about 3820 ppm/° C. The TCR of about 3800-3820 ppm/° C. was measured when no Rh was added to the solid portion. The TCR of about 3730-3750 ppm/° C. was measured when about 0.08 wt % of Rh was present in the solid portion. The TCR further decreased to about 3685 ppm/° C. with 0.16 wt % of Rh present in the solid portion of a resistive composition.

It is believed that adding one or more alloy forming metals such as Ir, Pd, Au, or Ag to Pt would form an alloy with Pt, and reduce the TCR of a platinum-alumina thick film resistor. Similar to Rh, either solid or liquid precursor for metal can be used in adding one or more alloy forming metals to the resistive thick film composition. For example, at least one of aforementioned alloy forming metals can be added in a solution of organo-metallic compound or inorganic salt. When the alloy forming metals are provided to Pt, D50 of the alloy forming metals is smaller than D50 of platinum. It is noted that a given amount of each metal causes a different rate of variation in the TCR of the resistive composition to form the thick film resistor after firing.

Organic Vehicle

The vehicle is a binder in an organic solvent or a binder in water. The binder used herein is not critical; conventional binders such as ethyl cellulose, polyvinyl butyral, and hydroxypropyl cellulose, and combinations thereof are appropriate in combination with a solvent. The organic solvent is also not critical and can be selected in accordance with a particular application method (i.e., printing or sheeting), from conventional organic solvents such as butyl carbitol, acetone, toluene, ethanol, diethylene glycol butyl ether; 2,2,4-trimethyl pentanediol monoisobutyrate (Texanol™); alpha-terpineol; beta-terpineol; gamma terpineol; tridecyl alcohol; diethylene glycol ethyl ether (Carbitol™), diethylene glycol butyl ether (Butyl Carbitol™) and propylene glycol; Acryloid® polymer products, and blends thereof, Products sold under the Texanol® trademark are available from Eastman Chemical Company, Kingsport, Tenn.; those sold under the Dowanol® and Carbitol® trademarks are available from Dow Chemical Co., Midland, Mich. Alternatively, the binder could be selected from polyvinyl alcohol (PVA), polyvinyl acetate (PVAC) in combination with water. Also, commercially available vehicles from Ferro Corporation having product numbers ER2750, ER2761, ER2766 and ER2769, and others, and combinations thereof, are suitable.

No particular limit is imposed on the organic vehicle content of the resistive composition. In one embodiment, the resistive composition contains from about 2 to about 4 wt % of the binder and from about 8 to about 16 wt % of the organic solvent, with the balance being the solid portion for a resistive composition.

If desired, a resistive composition contains up to about 5 wt % of other additives such as dispersants, plasticizers, and thixotropic additives.

Substrate and Methods

In one embodiment of the present invention, resistive thick film compositions include platinum particles, alumina particles, and organic vehicles. In another embodiment, resistive thick film compositions include platinum particles, alumina particles, metallic additives, and organic vehicles. The platinum particles, alumina particles and other metal particles, if present, are typically dispersed in an organic-based vehicle to produce a resistive thick film composition, a resistive paste or a resistive ink, that can be applied to a substrate by any of a variety of techniques, including screen printing, ink-jet printing and spraying. In one embodiment, the substrate includes commercially-available alumina substrate (96%, 99.5%, etc. from CoorsTek). Alternately, pre-fired alumina substrate can be made for densifying the alumina tapes by firing at 1550-1600° C. prior to applying the resistive thick film compositions on the alumina substrate. In other embodiments, the substrate includes zirconia toughened alumina (ZTA), aluminum nitride (AlN), or silicon nitride (Si₃N₄).

The deposited resistive composition can optionally be dried before being fired to form a thick film resistor on a substrate. The resistive compositions are fired at an elevated temperature of, for example, from about 1250° C. to about 1500° C. for about 30 minutes to about 90 minutes in ambient atmosphere. In one embodiment, the resistive composition is fired at about 1350° C.

After firing, the physical properties of thick film resistors on the substrate were measured based on the following methods.

It is noted that the resistive compositions disclosed herein according to several embodiments of the present invention, regardless of the ratio between platinum particles and alumina particles, can be fired at the temperature range indicated above, and no substantial difference in terms of adherence of the fired resistor to the substrate was observed. Accordingly, for example, resistive compositions including 35 vol % platinum particles and 60 vol % platinum particles fired at about 1350° C. do not show any substantial difference in adhering to the underlying substrate relative to other proportions disclosed herein. The adhesion of thick film resistor was measured based on ASTM D4541-17, Standard Test Method for Pull-Off Strength of Coatings Using Portable Adhesion Testers, such method incorporated herein by reference.

FIG. 7 shows the thick film resistors 20 formed on the pre-fired alumina substrate 30 and fired at about 1350° C. for about 30 minutes in ambient atmosphere. The image clearly indicates that the thick film resistor layer 20 in upper portion, and alumina substrate 30 in lower portion of the image. The thick film resistor layer 20 includes platinum particles (bright colored). Alumina particles in the thick film resistor layer 20 are sintered during firing to form connections with surrounding alumina particles (dark colored). The alumina particles (dark colored) in the thick film resistor 20 are sintered to form a continuous connection surrounding the platinum particles, and also bond with the underlying alumina substrate 30. As shown, the bonding of alumina particles to alumina substrate is seamless, and full adhesion between the resistor 20 and the alumina substrate 30 was achieved. The platinum particles seem to be dispersed in the thick film resistor 20, and not connected to each other. On the other hand, platinum particles are connected in 3-dimension to provide electrical conductivity. Due to alumina-alumina bonding, no discernable interface layer exists between the thick film resistor 20 and the underlying pre-fired alumina substrate 30. After firing, the thickness of the thick film resistor 20 including platinum and alumina was about 15-16 microns. The absence of an interface is also partially due to the controlled composition of the solid portion in the resistive composition. While a seamless interface is of great benefit in providing high adhesion of the film to the substrate, it is not a requirement for this invention to produce a useful and novel product.

As described above, the resistive composition does not include any alkali element, metallic elements such as Fe, Ni, Mn, Co, Cu, or Cr or their oxides or reducible oxides. The resistivity of a thick film resistor would not be fully controllable due to the presence of one or more alkali elements, which are known to be electrically conductive and mobile. In particular, during the operation of the sensor or electronic devices including the thick film resistor at an elevated temperature, the resistivity of the thick film resistor can change due to the elevated mobility of alkali ion. Similarly, the presence of reducible oxides such as ZnO, FeO, CoO, Cr₂O₃, PbO, CdO, or Bi₂O₃, can be affected by the electrical input applied to the resistor, and can reduce the oxide to metal. The uncontrolled reduction of oxides is unfavorable in controlling the resistivity of the thick film resistor during the operation of the sensor or other detectors.

Typically the presence of interface layer between any functional layer such as resistor and/or conductor, and the substrate can be problematic. The interface can be one of the sources for impurity and can modify the resistivity/conductivity of the resistor/conductor during the operation. In addition, the presence of an interface layer is unfavorable for controlling the mechanical stability of the thick film resistor on the substrate.

More importantly, the resistive composition according to embodiments of the present invention has an advantage of lowering the firing temperature of the thick film resistor ranging from about 1250° C. to about 1500° C. without compromising any mechanical and electrical properties of the thick film resistors when compared to high temperature co-fired ceramics (HTCC) with typical firing temperature ranging from about 1450° C. to about 1550° C. In one embodiment, the thick film resistor can be fully fired at about 1350° C., and showed excellent adherence to the underlying substrate. Firing of the thick film resistor disclosed herein at the temperature range as low as from about 1250° C. to about 1500° C. can be at least partially due to fine particle size for platinum and alumina that promotes the solid state reaction between the alumina particles in the resistive composition and the underlying substrate.

Laser Trimming

Thick film resistors can include resistor elements with different shapes and dimensions. In the thick film based manufacturing, for example, in the screen printing process, the resistor elements is formed on a substrate by patterns defined in the screen. The resistor elements formed on a substrate can have variation or inaccuracy from the resistance design value due to the nature of the screen printing process. After the resistor elements on a substrate are fired, depending on the requirements of resistivity of resistor elements, the resistor elements are further trimmed to reduce the variation of resistance in the resistor elements. In one example, Nd-YAG laser with wavelength of 1064 nm can be used to trim the thick film resistors formed on the substrate. In one embodiment, the thick film resistors are trimmed to have a pattern width of about 25 micron or less. The processing conditions for the laser trimming process are shown in Table 3.

TABLE 3
Process Parameters for Laser Trimming using an Nd-YAG laser.

| Laser parameters | Preferred Range | | More Preferred Range | |
|---|---|---|---|---|
| Average power | 0.5-10 | Watts | 1-3 | Watts |
| Wavelength | 1064 | nm | 1064 | nm |
| Q-Rate | 1-20 | kHz | 2-6 | kHz |
| Trim Speed | 1-300 | mm/second | 10-50 | mm/second |
| Spot Size | 20-50 | micron | ~30 | micron |

In one embodiment of the present subject matter, the resistive composition including predetermined amount of platinum particles and ceramic particles (ex. alumina) according to any embodiment of the present subject matter can further include about 0.1 vol % to about 10 vol % dark colored additive. For example, the incorporation of RuO₂ in the resistive composition can be advantageous in forming a darker-colored resistor, which allows better absorption of irradiation from the laser source during trimming process. RuO₂ is provided in either solid or liquid precursor form to be mixed with platinum particles and ceramic particles (ex. alumina) in the resistive composition. Accordingly, the resistor elements can be laser trimmed with improved efficiency.

In accordance with the invention, there is provided a resistive composition for forming a thick film resistors on a substrate. The resistive composition comprises platinum particles and ceramic particles. The ceramic particles include alumina particles. The resistive composition is devoid of at least one of the glass compositions, alkali metals and oxides, metallic elements such as Fe, Ni, Mn, Co, Cu, or Cr and their oxides, and reducible oxides, and preferably excludes all of the foregoing. It has been found that the thick film resistors according to the present invention provide full adhesion with the substrate. Further, the thick film resistors according to the present invention can be manufactured by thick film process, which could significantly reduce manufacturing cost over the existing thin film process which require costly investment and correspondingly high production cost.

The invention is further defined by the following items.

Item 1. A resistive composition comprising, prior to firing:

an organic portion, and

a solid portion comprising:
from about 30 to about 70 vol % platinum (Pt) particles, and
from about 30 to about 70 vol % alumina (Al₂O₃) particles,
wherein D50 of platinum particles is from about 0.3 micron to about 3.0 micron, and D50 of alumina particles is from about 0.05 micron to about 0.6 micron.

Item 2. The resistive composition of item 1, wherein

D10 of platinum particles is from about 0.1 micron to about 2.0 micron,

D90 of platinum particles is from about 5.0 micron to about 7.5 micron,

D10 of alumina particles is from about 0.01 micron to about 0.09 micron, and

D90 of alumina particles is from about 0.2 micron to about 0.8 micron.

Item 3. The resistive composition of item 1, wherein

D50 of platinum particles is from about 0.7 micron to about 2.0 micron, and

D50 of alumina particles is from about 0.05 micron to about 0.25 micron.

Item 4. The resistive composition of item 3, wherein

D10 of platinum particles is from about 0.1 micron to about 1.0 micron,

D90 of platinum particles is from about 4.0 micron to about 5.5 micron,

D10 of alumina particles is from about 0.01 micron to about 0.05 micron, and

D90 of alumina particles is from about 0.2 micron to about 0.5 micron.

Item 5. The resistive composition of item 1, wherein

D50 of platinum particles is from about 1.0 micron to about 1.8 micron, and

D50 of alumina particles is from about 0.07 micron to about 0.18 micron.

Item 6. The resistive composition of item 5, wherein

D10 of platinum particles is from about 0.2 micron to about 0.6 micron,

D90 of platinum particles is from about 1.7 micron to about 4.0 micron,

D10 of alumina particles is from about 0.01 micron to about 0.03 micron, and

D90 of alumina particles is from about 0.2 micron to about 0.4 micron.

Item 7. The resistive composition of item 1, wherein

D50 of platinum particles is about 1.5 micron, and

D50 of alumina particles is about 0.1 micron.

Item 8. The resistive composition of item 1, wherein the solid portion comprises:

from about 35 to about 50 vol % platinum (Pt) particles, and

from about 50 to about 65 vol % alumina (Al₂O₃) particles.

Item 9. The resistive composition of item 7, wherein

D10 of platinum particles is from about 0.3 micron to about 0.6 micron, D90 of platinum particles is from about 2.1 micron to about 2.8 micron,

D10 of alumina particles is from about 0.01 micron to about 0.03 micron, and D90 of alumina particles is from about 0.15 micron to about 0.4 micron.

Item 10. The resistive composition of item 7, wherein

D10 of platinum particles is about 0.5 micron,

D90 of platinum particles is about 2.5 micron,

D10 of alumina particles is about 0.03 micron, and

D90 of alumina particles is about 0.3 micron.

Item 11. The resistive composition of item 1, wherein

D10 of platinum particles is about 0.2 micron,

D90 of platinum particles is about 5.0 micron,

D10 of alumina particles is about 0.01 micron, and

D90 of alumina particles is about 1.0 micron.

Item 12. The resistive composition of claim 1, wherein

a specific surface area of platinum particles is from about 0.3 m²/g to about 1.1 m²/g, and

a specific surface area of alumina particles is from about 10 m²/g to about 20 m²/g.

Item 13. The resistive composition of claim 12, wherein

a specific surface area of platinum particles is from about 0.6 m²/g to about 0.7 m²/g, and

a specific surface area of alumina particles is from about 14 m²/g to about 15 m²/g.

Item 14. The resistive composition of item 1, further comprising:

from about 0.1 vol % to about 10 vol % RuO₂.

Item 15. The resistive composition of any of items 1-14,

wherein the resistive composition is devoid of at least one of glass compositions, metallic elements, alkali metals, and reducible oxides,

wherein the metallic elements include at least one of Fe, Ni, Mn, Co, Cu, and Cr,

wherein the alkali metals includes at least one of Na, K, and Li, and

wherein the reducible oxides includes at least one of ZnO, FeO, CoO, Cr₂O₃, PbO, CdO, and Bi₂O₃.

Item 16. The resistive composition of item 15, wherein the resistive composition is devoid of the glass compositions, the metallic elements, the alkali metals, and the reducible oxides.

Item 17. The resistive composition of any of items 1-16, further comprising at least one of Rh, Ir, Pd, Au, and Ag, wherein the amount of at least one of Rh, Ir, Pd, Au, and Ag ranges from about 0.01 and about 10 vol %.

Item 18. The resistive composition of any of items 1-17, wherein at least one of Rh, Ir, Pd, Au, and Ag is added as particle, and D50 of at least one of Rh, Ir, Pd, Au, and Ag is smaller than D50 of platinum.

Item 19. The resistive composition of any of items 1-17, wherein at least one of Rh, Ir, Pd, Au, and Ag is added in a solution of organo-metallic compound or inorganic salt.

Item 20. The resistive composition of any of items 1-17, wherein the platinum particle and the alumina particle have non-spherical morphology.

Item 21. The resistive composition of item 1, wherein the organic portion includes texanol, ethyl cellulose, and acryloid polymer.

Item 22. The resistive composition of item 1, wherein the solid portion comprises:

from about 30 to about 70 vol % platinum (Pt) particles; and

from about 30 to about 70 vol % mixture including alumina (Al₂O₃) and cordierite,

the mixture comprising:
from about 10 to about 90 vol % alumina (Al₂O₃) particles of the mixture, and
from about 10 to about 90 vol % cordierite particles of the mixture.

Item 23. A resistor film formed on a substrate by firing the resistive composition of any of items 1-20,

wherein the temperature coefficient of resistance (TCR) of the resistor film is from about 3685 to about 3925 ppm/° C.,

wherein the substrate is selected from alumina, zirconia toughened alumina, aluminum nitride, and silicon nitride, and

wherein no interface layer is formed between the film and substrate.

Item 24. The resistor film of item 22, wherein resistivity of the film ranges from about 0.05 to about 2 ohm per square.

Item 25. The resistor film of item 23, wherein the resistivity of the film ranges from about 0.15 to about 0.9 ohm per square.

Item 26. The resistor film of item 23, wherein the temperature coefficient of resistance (TCR) is from about 3750 to about 3900 ppm/° C.

Item 27. The resistor film of any of items 23-24, wherein the film thickness after the firing ranges from about 1 micron to about 25 micron.

Item 28. The resistor film of item 23, wherein the temperature coefficient of resistance (TCR) is from about 3685 to about 3820 ppm/° C.

Item 29. A method of forming a device comprising the steps of:

applying the resistive composition of any of items 1-22 to a substrate,

applying a conductive composition for forming at least one of a lead line and a pad for welding, and

firing the resistive composition and the conductive composition applied on the substrate at a temperature from about 1250° C. to about 1500° C.

Item 30. The method of item 29, wherein the substrate with the resistive composition and conductive compositions applied is fired at a temperature about 1350° C.

Item 31. The method of item 29, wherein the substrate with the resistive composition and conductive compositions applied is co-fired.

Item 32. The method of any of items 29-31, wherein the substrate is selected from alumina, zirconia toughened alumina, aluminum nitride, and silicon nitride.

Item 33. The method of any of items 29-32, wherein the firing temperature is less than a softening point of the substrate.

Item 34. The method of any of items 29-33, further comprising:

applying an overcoat composition.

Item 35. The method of item 29, further comprising:

forming a predetermined patterns by applying laser radiation,

wherein width of the predetermined pattern is about 25 micron.

Item 36. A device comprising:

a resistor film comprising a solid portion of any of items 1-22, prior to firing, on a substrate, and

a lead line for connecting to an exterior device,

wherein the substrate is selected from alumina, zirconia toughened alumina, aluminum nitride, and silicon nitride.

Item 37. The device of item 36, further comprising:

an overcoat for covering at least a portion of the resistor film,

wherein the overcoat comprises a glass composition, ceramic, or combinations thereof.

Item 38. The device of item 36, wherein the resistor film comprises one of a serpentine pattern and an area pattern.

Item 39. The device of item 36, wherein the device includes a resistance temperature device (RTD), particulate matter (PM) sensor, and heater resistor.

Item 40. The device of item 36, wherein a temperature coefficient of resistance (TCR) of the resistor film ranges from about 3685 ppm/° C. to about 3925 ppm/° C.

Item 41. The device of item 36, wherein a temperature coefficient of resistance (TCR) of the resistor film ranges from about 3750 ppm/° C. to about 3900 ppm/° C.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scopes of the claimed subject matter, as expressed in the appended claims.

What is claimed is:

1. A resistive composition comprising, prior to firing:
an organic portion, and
a solid portion comprising:
from about 30 to about 70 vol % platinum (Pt) particles, and
from about 30 to about 70 vol % alumina (Al₂O₃) particles,
wherein D50 of platinum particles is from about 0.3 micron to about 3.0 micron, and D50 of alumina particles is from about 0.05 micron to about 0.6 micron.

2. The resistive composition of claim 1, wherein
D10 of platinum particles is from about 0.1 micron to about 2.0 micron,
D90 of platinum particles is from about 5.0 micron to about 7.5 micron,
D10 of alumina particles is from about 0.01 micron to about 0.09 micron, and
D90 of alumina particles is from about 0.2 micron to about 0.8 micron.

3. The resistive composition of claim 1, wherein
D50 of platinum particles is from about 0.7 micron to about 2.0 micron, and
D50 of alumina particles is from about 0.05 micron to about 0.25 micron.

4. The resistive composition of claim 3, wherein
D10 of platinum particles is from about 0.1 micron to about 1.0 micron,
D90 of platinum particles is from about 4.0 micron to about 5.5 micron,
D10 of alumina particles is from about 0.01 micron to about 0.05 micron, and
D90 of alumina particles is from about 0.2 micron to about 0.5 micron.

5. The resistive composition of claim 1,
wherein the resistive composition is devoid of at least one of glass compositions, metallic elements, alkali metals, and reducible oxides,
wherein the metallic elements include at least one of Fe, Ni, Mn, Co, Cu, and Cr,
wherein the alkali metals includes at least one of Na, K, and Li, and
wherein the reducible oxides includes at least one of ZnO, FeO, CoO, Cr₂O₃, PbO, CdO, and Bi₂O₃.

6. The resistive composition of claim 1, wherein the resistive composition is devoid of the glass compositions, the metallic elements, the alkali metals, and the reducible oxides.

7. The resistive composition of claim 1, further comprising at least one of Rh, Ir, Pd, Au, and Ag, wherein the amount of at least one of Rh, Ir, Pd, Au, and Ag ranges from about 0.01 and about 10 vol %.

8. The resistive composition of claim 1, wherein the solid portion comprises:
from about 30 to about 70 vol % platinum (Pt) particles, and
from about 30 to about 70 vol % mixture including alumina (Al₂O₃) and cordierite, the mixture comprising:
from about 10 to about 90 vol % alumina (Al₂O₃) particles of the mixture, and
from about 10 to about 90 vol % cordierite particles of the mixture.

9. A resistor film formed on a substrate by firing the resistive composition of claim 1,
wherein the temperature coefficient of resistance (TCR) of the resistor film is from about 3685 to about 3925 ppm/° C.,
wherein the substrate is selected from alumina, zirconia toughened alumina, aluminum nitride, and silicon nitride, and
wherein no interface layer is formed between the film and substrate.

10. The resistor film of claim 9, wherein resistivity of the film ranges from about 0.05 to about 2 ohm per square.

11. The resistor film of claim 9, wherein the film thickness after the firing ranges from about 1 micron to about 25 micron.

12. A method of forming a device comprising the steps of:
applying the resistive composition of claim 1 to a substrate,
applying a conductive composition for forming at least one of a lead line and a pad for welding, and
firing the resistive composition and the conductive composition applied on the substrate at a temperature from about 1250° C. to about 1500° C.

13. The method of claim 12, wherein the substrate with the resistive composition and conductive compositions applied is fired at a temperature about 1350° C.

14. The method of claim 12, wherein the substrate with the resistive composition and conductive compositions applied is co-fired.

15. The method of claim 12, wherein the substrate is selected from alumina, zirconia toughened alumina, aluminum nitride, and silicon nitride.
